(19) United States
(12) Patent Application Publication
(10) Pub. No.: US 2007/0159657 A1
(43) Pub. Date: Jul. 12, 2007

(54) Image forming apparatus

(75) Inventors: Issei Nakano, Osaka-shi (JP); Jun Nakai, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/649,195

(22) Filed: Jan. 3, 2007

(30) Foreign Application Priority Data
Jan. 10, 2006 (JP) 2006-002778

(51) Int. Cl. G06F 15/00

(52) U.S. Cl. 358/3.13; 358/1.9

(57) ABSTRACT

An input dither pattern determiner divides an input dither image to plural blocks, and determines an input dither pattern for each block. An output dither image portion converts the input dither pattern for each block to an output dither pattern. A reference emission time determiner portion determines a reference emission time for each block based on dark electric potential distribution and intermediate sensitivity distribution of a photoconductive drum, a light intensity distribution of a laser beam in a main scanning direction, and the output dither pattern. An area emission time calculator determines area emission time for each area based on a reference emission time for each block. An actual emission time calculator adjusts emission time for each area so that differences between reference emission times of blocks adjacent one another in the main scanning direction become a predetermined value or lower, and calculates actual emission time for each area.

### BACKGROUND OF THE INVENTION

1. Field of the Invention

The present invention relates to an image forming apparatus such as a network printer, a digital composite machine, a copying machine and a facsimile apparatus.

2. Description of the Related Art

U.S. Pat. No. 5,134,495 discloses a pseudo high resolution technique. According to this technique, for example, even in the case where an original image having a resolution of 1200 dpi is to be formed by a printer having a reproducible resolution of 600 dpi, the printer simulatedly reproduces a 1200 dpi image by adjusting an emission time of a laser beam for each pixel.

FIG. 12 is a diagram for describing the technique disclosed in the U.S. Pat. No. 5,134,495. The technique disclosed in the U.S. Pat. No. 5,134,495 is described in accordance with FIG. 12. At first, an original image transmitted from a device such as a personal computer is converted to an input dither image by a known dither method. The input dither image is divided into a plurality of blocks, and it is determined which one of advancedly-prepared input dither patterns (input templates) A, B, . . . corresponds to a dither pattern of each block. Then, the determined input dither pattern is converted to an output dither pattern (output template) A, B, . . . prepared in advance for each input dither pattern A, B, . . . . Consequently, the input dither image is converted to an output dither image consisting of the output dither patterns. Herein, each output dither pattern has a corresponding emission time of a laser beam which makes a pixel be interpolated between one pixel and another adjacent pixel on an image bearing member. Thus, if the output dither image is exposed in accordance with the respective emission times of a laser beam corresponding to the respective output dither patterns, the printer can reproduce an image having a resolution of 1200 dpi even though it has a reproducible resolution of only 600 dpi.

FIG. 13 is a diagram for describing a condition where pixels are interpolated as a result of an emission of a laser beam in accordance with output dither patterns A, B. In FIG. 13, output dither patterns 801 show two output dither patterns A, B. An output image 802 shows the interpolated pixels. A graph 803 shows a light intensity distribution in a sub scanning direction of a laser beam. In the graph 803 shown in FIG. 13, a vertical axis indicates strength, and a horizontal axis indicates a sub scanning direction.

In FIG. 13, lines each marked as a 600 dpi line indicates scanning lines actually scanned by a laser beam. A line marked as a 1200 dpi line indicates a scanning line on which pixels are interpolated. Each of the output dither patterns A, B consists of 4×4 pixels. A right ward direction indicates a main scanning line, and a downward direction shows a sub scanning direction. According to the output dither pattern A, the laser beam is emitted for four pixels respectively positioned in upper left hand at the first row, first column, the second row, first column, the first row, second column, and the second row, first column. According to the output dither pattern B, the laser beam is emitted for four pixels respectively positioned at the second row, second column, the third row, second column, the first row, fourth column, and the second row, fourth column.

Further, a width in the main scanning direction of each rectangular area applied with hatching shown in the output dither patterns 801 indicates an emission time of the laser beam. In the output dither patterns 801, a width in the main scanning direction of each of the rectangular areas shown in the output dither pattern B is larger than a width in the main scanning direction of each of the rectangular areas shown in the output dither pattern A. Accordingly, it can be seen that a pulse emission time of the output dither pattern B is larger than that of the output dither pattern A.

When the pixels of the first row, fourth column and the second row, fourth column included in the output dither pattern B shown in the output image 802 are exposed by the laser beam at an emission time and output power in accordance with the output dither pattern B, for example as shown in the graph 803, a light intensity distribution B1 in the sub-scanning direction of a laser beam strength with respect to the pixel of the first row, fourth column and a light intensity distribution B2 in the sub-scanning direction of a laser beam strength with respect to the pixel of the second row, fourth column are overlapped. Accordingly, a light intensity distribution B3 can be obtained. Consequently, a pixel is interpolated on the 1200 dpi line positioned at an intermediate position between the 600 dpi line in the first row and the 600 dpi line in the second row, each shown in the output image 802, so that a resolution of 1200 dpi can be simulatedly reproduced.

However, since a dark electric potential distribution, an intermediate sensitivity distribution, and a light sensitivity distribution at respective positions in the main scanning direction of the laser beam are not taken in consideration at all in the technique shown in the U.S. Pat. No. 5,134,495, adequate combined latent pixels cannot be formed. Accordingly, further modification is desired for improving an image reproducibility.

### SUMMARY OF THE INVENTION

An object of the present invention is to further improve image reproducibility in the case whereat the time when an image forming is performed with use of pseudo high resolution technique.

An image forming apparatus according to one aspect of the present invention is adapted for forming on a recording sheet an original image having a higher resolution than a reproducible resolution by pseudo high resolution technique. The image forming apparatus comprises: an input dither image producing portion for producing an input dither image by converting an original image to a dither image; an input dither pattern determining portion for dividing the input dither image to a plurality of blocks, and determining which one of advancedly-prepared input dither patterns corresponds to a dither pattern of each block; an output dither image producing portion for producing an output dither image by converting the input dither pattern determined for each block in accordance with an advancedly-prepared output dither pattern for each input dither pattern to simulatedly form on a recording sheet the original image at a resolution of the original image; a reference emission time determining portion for determining a reference emission time indicating a laser beam emission time for each of pixels forming each block to correct, based on a dark electric potential distribution and an intermediate sensitivity distribution of an image bearing member, a light intensity distribution of a laser beam in a main scanning direction, and the output dither patterns, scatterings in the dark electric potential, the intermediate sensitivity, and the light intensity, and simulatedly form the output dither image at the resolution of the original image; and an actual emission time calculating portion for calculating an actual emission time indicating the emission time for each block that is adjusted such that a difference between the respective reference emission times of the blocks adjacent to each other in the main scanning direction becomes a predetermined value or lower.

These and other objects, features, aspects, and advantages of the present invention will become more apparent from the following detailed description of the preferred embodiments/examples with reference to the accompanying drawings.

### BRIEF DESCRIPTION OF THE DRAWINGS

FIG. 1 is a side schematic diagram mainly showing a mechanical construction of an image forming apparatus according to an embodiment of the present invention.

FIG. 2 is a block diagram showing an electric construction of the image forming apparatus shown in FIG. 1.

FIG. 3 is a graph showing one example of a dark electric potential distribution stored in a dark electric potential distribution storing portion, an intermediate sensitivity distribution stored in an intermediate sensitivity distribution storing portion, and a light intensity distribution in a main scanning direction of a laser beam stored in a light intensity distribution storing portion.

FIGS. 4A to 4C are diagrams respectively showing an output dither pattern exposed by the image forming apparatus having features shown in FIG. 3. FIG. 4A shows an emission time in the area A in FIG. 3. FIG. 4B shows an emission time in the area B in FIG. 3. FIG. 4C shows an emission time in the area C in FIG. 4.

FIG. 5 is a flowchart showing one example of an operation of the image forming apparatus according to the embodiment.

FIGS. 6A, 6B are diagrams showing a relation between each of blocks constructing the output dither image and respective exposing positions. FIG. 6A is a diagram showing blocks set for the output dither image, and FIG. 6B is a diagram showing a photoconductive drum.

FIG. 7 shows tables showing an example of a reference emission time determined by a reference emission time determining portion.

FIG. 8 is a diagram for describing a processing of calculating an area emission time performed by an area emission time calculating portion.

FIG. 9 is a flowchart showing detailed processing of Step S12 shown in FIG. 5.

FIG. 10 is a diagram for describing processings performed in steps S23 through S25 shown in FIG. 9.

FIGS. 11A to 11C are diagrams for describing a merit in the case whereof calculating actual emission times consecutively from the largest area emission time area toward an area positioned at an end. FIG. 11A is a diagram showing a case where actual emission times are not calculated consecutively from the largest area emission time area. FIG. 11B is a diagram showing the case where actual emission times are calculated consecutively from the largest area emission time area at a left end. FIG. 11C is a diagram showing the case where actual emission times are calculated consecutively from the largest emission time area in a vicinity of a central portion.

FIG. 12 is a diagram for describing a technique disclosed in the U.S. Pat. No. 5,134,495.

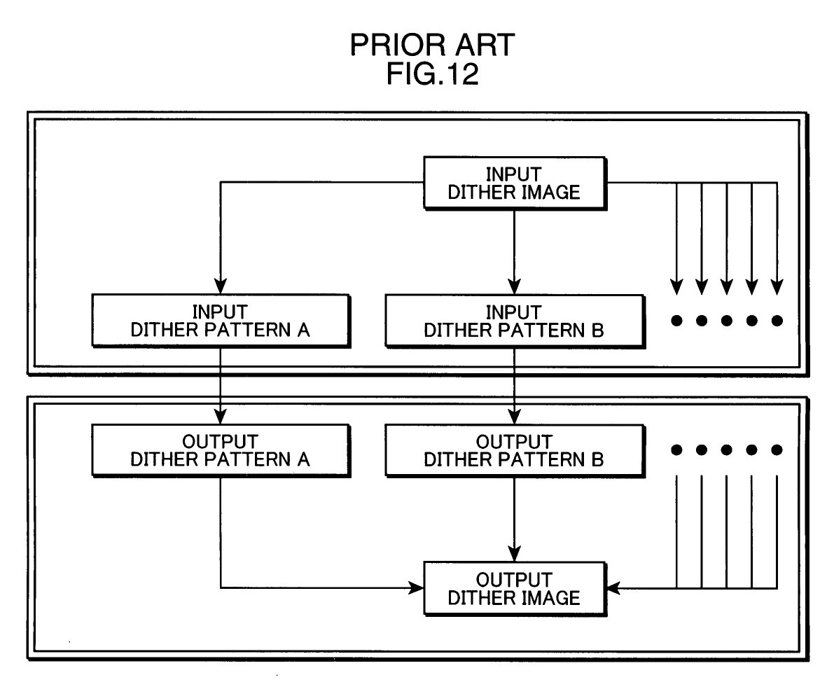

FIG. 13 is a diagram for describing a condition where a pixel is interpolated as a result of emission of a laser beam in accordance with the output dither pattern.

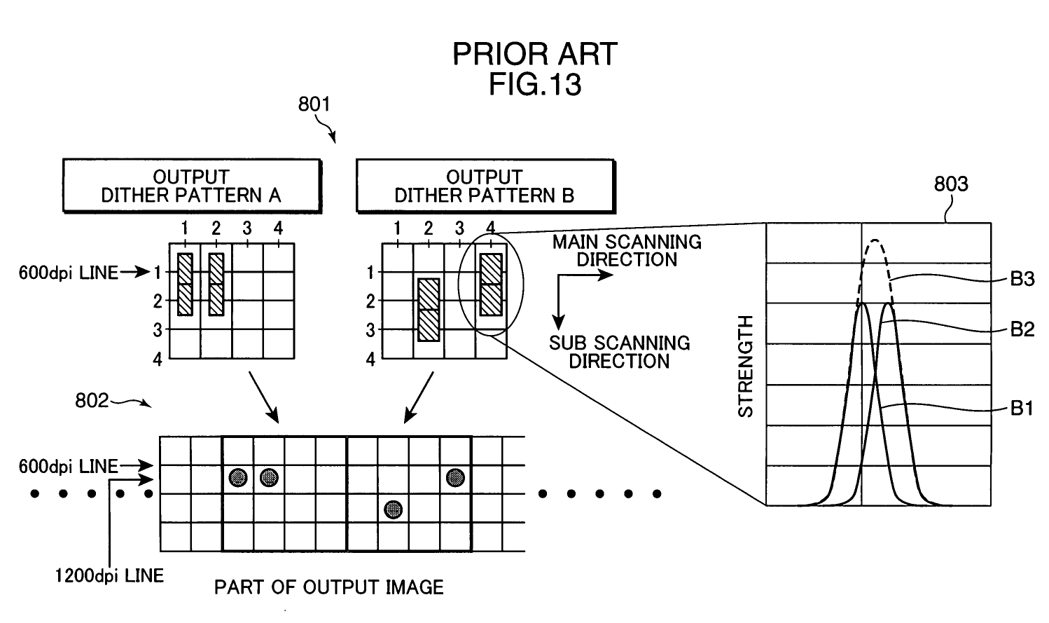

### DETAILED DESCRIPTION OF THE PREFERRED EMBODIMENTS

Hereinafter, an embodiment of the present invention is described with reference to the attached drawings. It should be noted that the embodiment described herebelow is one example embodying the present invention, and is not the one having a characteristic of limiting a technical scope of the present invention.

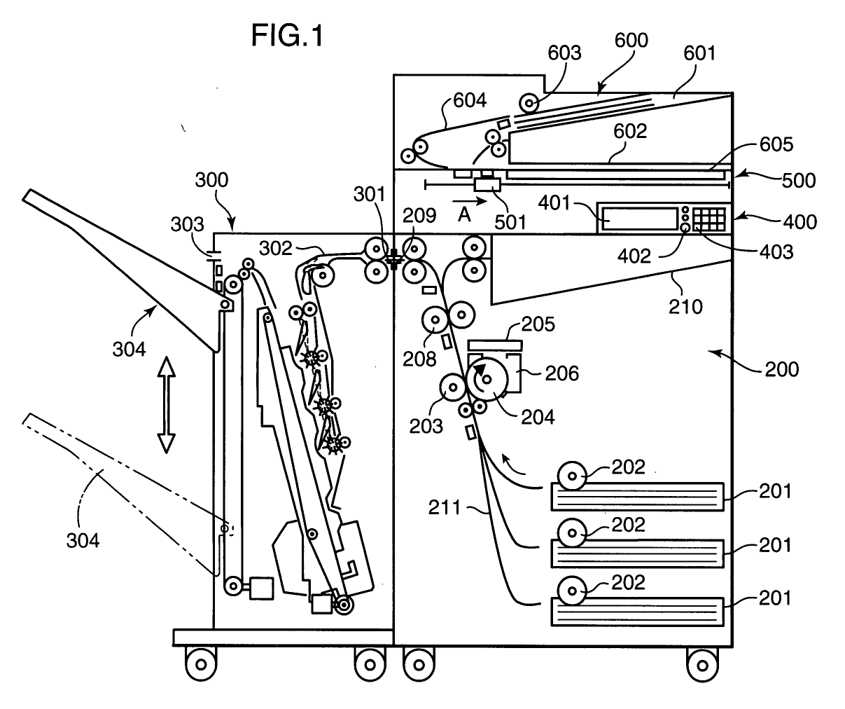

FIG. 1 is a side schematic diagram mainly showing a mechanical construction of an image forming apparatus according to the embodiment of the present invention. The image forming apparatus includes a main body 200, a sheet post processing section 300 provided in a left side of the main body 200, an operating section 400 for allowing a user to input various operating instructions and the like, a document reading section 500 provided in an upper portion of the main body 200, and a document feeding section 600 provided on an upper portion of the document reading section 500.

The operating section 400 includes a display panel 401, a start key 402, numerical keys 403 and the like. The display panel 401 is constructed by a touch panel and is adapted for displaying various operating images and displaying various operating buttons and the like for allowing a user to input various operating instructions. The operating button includes a size enlargement setting button and a size reduction setting button. The size enlargement setting button is adapted for allowing a user to input an instruction to enlarge a font size. The size reduction setting button is adapted for allowing a user to input an instruction to reduce a font size. The start key 402 is adapted for allowing a user to input a printing executing instruction. The numerical key 403 is adapted for allowing a user to input the number of printings and the like.

The document feeding section 600 includes a document holding portion 601, a document discharging portion 602, a sheet feeding roller 603, a document conveying portion 604, a contact glass 605 and the like. The document reading section 500 includes a scanner 501 and the like. The sheet feeding roller 603 is adapted for sending out a document held on the document holding member 601. The document conveying portion 604 is adapted for conveying a document sent out by the sheet feeding roller 603 one after another onto the scanner 501.

The scanner 501 reads the conveyed document consecutively, and the read document is discharged to the document discharging portion 602. Further, in the case of reading out a document placed on the contact glass 605, the scanner 501 moves slidingly in a direction of an arrow A to read out the document in the case where.

The main body 200 includes a plurality of sheet feeding cassettes 201, a plurality of sheet feeding rollers 202, a transferring roller 203, a photoconductive drum 204, an exposing device 205, a developing device 206, a fixing roller 208, a discharging opening 209, a discharging tray 210, a recording sheet conveying portion 211 and the like.

The photoconductive drum 204 is uniformly charged by a charging device (unillustrated) while being rotated in a direction of an arrow. The exposing device 205 converts a modulating signal generated based on an image data of a document read out in the document reading section 500 to a laser light ray and outputs the same to form on the photoconductive drum 204 electrostatic latent images for respective colors. The developing device 206 supplies developers of respective colors to the photoconductive drum 204 to thereby form toner images of respective colors.

On the other hand, the sheet feeding roller 202 picks up a recording sheet from the sheet feeding cassette 201 in which a recording sheet is stored. The recording sheet conveying portion 211 conveys the picked recording sheet to the transferring roller 203. The transferring roller 203 transfers a toner image formed on the photoconductive drum 204 to the conveyed recording sheet. The recording sheet to which the toner image is transferred is conveyed to the fixing roller 208 by the recording sheet conveying portion 211. The fixing roller 208 heats the transferred toner image to fix the same onto the recording sheet. After that, the recording sheet is conveyed to the discharging opening 209 by the recording sheet conveying portion 211. Then, the recording sheet is conveyed to the sheet post processing section 300. Further, the recording sheet may also be discharged to the discharging tray 210 if necessary.

The sheet post processing section 300 includes an inlet opening 301, a recording sheet conveying portion 302, an outlet opening 303, a stack tray 304 and the like. The recording sheet conveying portion 302 consecutively conveys a recording sheet conveyed from the outlet opening 209 to the inlet opening 301, and finally discharges the recording sheet through the outlet opening 303 to the stack tray 304. The stack tray 304 is so constructed that it can move upward and downward in directions of arrows in accordance with the number of stacked recording sheets which are conveyed from the outlet opening 303.

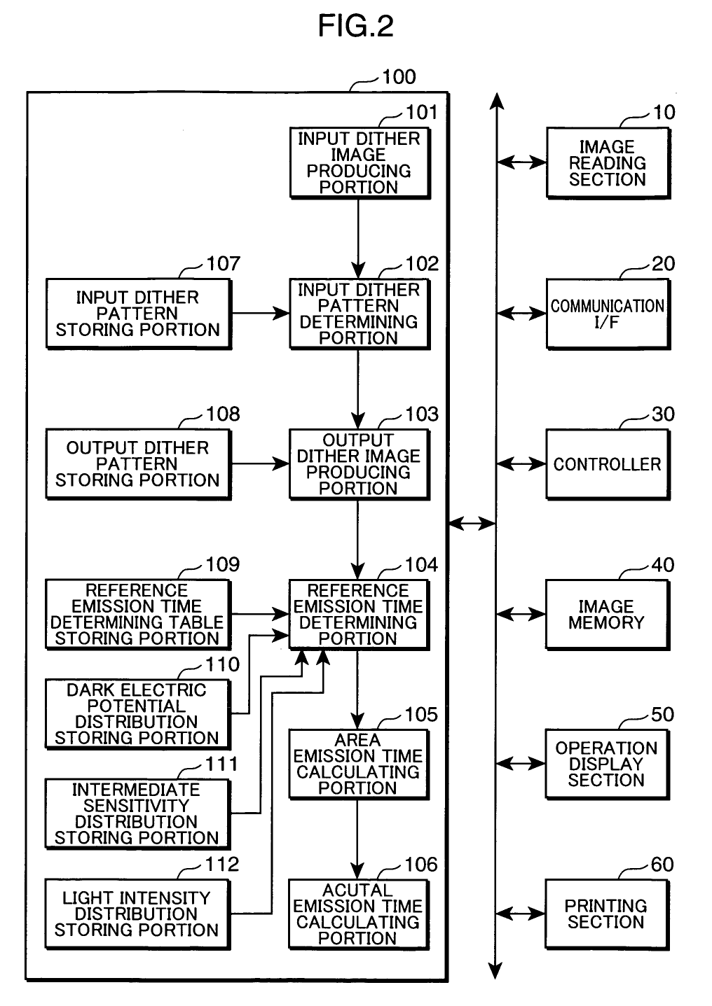

FIG. 2 is a block diagram showing an electric construction of the image forming apparatus shown in FIG. 1. The image forming apparatus includes a document reading section 10, a communication interface (I/F) 20, a controller 30, an image memory 40, an operation display section 50, a printing section 60 and an image processing section 100.

The document reading section 10 is constructed by the document reading section 500 shown in FIG. 1 and is adapted for obtaining an image data of a document which is subjected to a copying. The communication I/F 20 is constructed by a LAN board and the like and is adapted for receiving an image data subjected to a printing and transmitted from a computer which is connected through a LAN.

The controller 30 is constructed by a CPU, a ROM, a RAM and the like and is adapted for controlling a whole image forming apparatus. The image memory 40 is constructed by an external memory device such as a hard disk and is adapted for storing an image data which is obtained by the document reading section 10 or received by the communication I/F 20.

The operation display section 50 displays various operation images on the display panel 401 under control of the controller 30. The printing section 60 is constructed by the transferring roller 203, the photoconductive drum 204, the exposing device 205, the developing device 206 and the like shown in FIG. 1 and is adapted for printing an image data to which an image processing is applied by the image processing section 100 onto a recording sheet.

The image processing section 100 is constructed by an application specified integral circuit (ASIC) and the like, and is adapted for applying a predetermined image processing to an image data of a document which is obtained by the document reading section 10 and an image data which is received by the communication I/F 20 and outputting the processed image data to the printing section 60.

Particularly in the present embodiment, the image processing section 100 includes an input dither image producing portion 101, an input dither pattern determining portion 102, an output dither image producing portion 103, a reference emission time determining portion 104, an area emission time calculating portion 105, an actual emission time calculating portion 106, an input dither pattern storing portion 107, an output dither pattern storing portion 108, a reference emission time determining table storing portion 109, a dark electric potential distribution storing portion 110, an intermediate sensitivity distribution storing portion 111, and a light intensity distribution storing portion 112.

The input dither image producing portion 101 reads out from the image memory 40 an image data of one original image which is specified by the controller 30 and subjected to a printing, and converts the image data of the original image to a dither image by applying a known dither method such as an ordered dither method to the read-out image data. Herein, the image data of the original image is a monochromatic multi-valued image. Further, a dither image produced by the input dither image producing portion 101 is herein called an input dither image. Furthermore, the input dither image is a binary image.

The input dither pattern determining portion 102 divides the input dither image into a plurality of blocks consisting of the total number of 64 pixels, which is a multiplication of predetermined rows by predetermined columns (for example, 8 rows by 8 columns), and determines which one of a various kinds of input dither patterns stored in the input dither pattern storing portion 107 corresponds to a dither pattern appears on each block by a known template matching. It should be noted that the details of this processing are disclosed in the U.S. Pat. No. 5,134,495.

The output dither image producing portion 103 produces an output dither image constructed by output dither patterns by converting the input dither pattern determined for each block with reference to the output dither pattern storing portion 108 to an output dither pattern prepared in advance for each input dither pattern. Herein, the output dither pattern has a resolution which is half the resolution of the input dither pattern. However, the dither pattern is so constructed that a resolution of the input dither pattern can be simulatedly reproduced in the case where the output dither pattern is exposed to the photoconductive drum 204. It should be noted that the details of this processing are disclosed in the U.S. Pat. No. 5,134,495.

The reference emission time determining portion 104 determines an exposing position of each block on the photoconductive drum 204, and determines a dark electric potential and an intermediate sensitivity at the determined exposing position on the photoconductive drum 204, and a light intensity of a laser beam irradiated to the photoconductive drum 204 by referring to the dark electric potential distribution storing portion 110, the intermediate sensitivity distribution storing portion 111 and the light intensity distribution storing portion 112. Then, the reference emission time determining portion 104 determines a reference emission time indicating a laser beam emission time for one pixel in each block based on the determined dark electric potential distribution, intermediate sensitivity distribution, light intensity distribution of a laser beam and output dithering pattern of each block by referring to the reference emission time determining table storing portion 109.

The area emission time calculating portion 105 divides each line of the output dither image to a plurality of areas in the main scanning direction at intervals of the predetermined numbers of pixels, and calculates a representative value (an average value, a median value and the like) of the reference emission time determined with respect to the output dither pattern falling in each area, and then calculates the calculated representative value as an area emission time which is an emission time for one pixel in each area. Herein, a size of each area is an integral multiplication of the numbers of pixels in the main scanning direction in each block. Thus, the area includes a plurality of the output dither patterns.

The actual emission time calculating portion 106 calculates an actual emission time indicating an actual emission time of a laser beam for one pixel. Particularly, the actual emission time calculating portion 106 calculates an actual emission time for each area such that a difference between an actual emission time for a particularly noticed area (particular area) and an actual emission time for an area adjacent thereto becomes one-tenth of the actual emission time for the adjacent area or lower.

The input dither pattern storing portion 107 stores various numbers of advancedly-prepared input dither patterns. The output dither pattern storing portion 108 stores output dither patterns which are dither patterns advancedly prepared for each input dither pattern. Herein, each output dither pattern has a dither pattern which is advancedly prepared for each input dither pattern to simulatedly form on the image for forming a recording sheet at a resolution of the original image. It should be noted that details of the output dither patterns are disclosed in the U.S. Pat. No. 5,134,495.

The reference emission time determining table storing portion 109 stores a reference emission time determining table which is used when the reference emission time determining portion 104 determines a reference emission time. The reference emission time determining table is a 4D table which stores a reference emission time corresponding to a dark electric potential, an intermediate sensitivity, a light intensity of the laser beam and the output dither pattern. Herein, the reference emission time determining table stores a reference emission time which is determined so that scatterings in the dark electric potential, the intermediate sensitivity and the light intensity is corrected, and that the output dither image is simulatedly formed at the resolution of the original image.

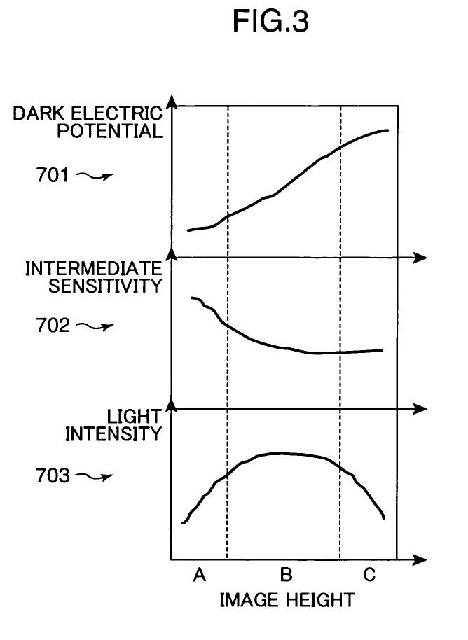

The dark electric potential distribution storing portion 110 stores a dark electric potential distribution of the photoconductive drum 204. A graph 701 in FIG. 3 shows an example of a dark electric potential distribution which is stored in the dark electric potential distribution storing portion 110. The graph 701 shown in FIG. 3 indicates a dark electric potential distribution in one line in the main scanning direction of the photoconductive drum 204. The vertical axis indicates a dark electric potential. The horizontal axis indicates a position (image height) in the main scanning direction of the photoconductive drum 204. Further, a left side end point of the graph 701 shown in FIG. 3 indicates an electric potential on a left end in the main scanning direction of an image forming area of the photoconductive drum 204, and a right end point indicates an electric potential on the right end in the main scanning direction of the image forming area of the photoconductive drum 204. As shown in the graph 701 in FIG. 3, it can be seen that the electric potential increases as a position moves from the left end to the right end. Furthermore, the dark electric potential distribution storing portion 110 stores such dark electric potential distributions for a plurality of lines. Furthermore, the dark electric potential distributions are advancedly obtained by an experiment and the like.

The intermediate sensitivity distribution storing portion 111 stores an intermediate sensitivity distribution of the photoconductive drum 204. The graph 702 in FIG. 3 shows an example of an intermediate sensitivity distribution stored in the intermediate sensitivity distribution storing portion 111. The graph 702 shown in FIG. 3 indicates an intermediate sensitivity distribution on the same line of the dark electric potential distribution shown in the graph 701. The vertical axis indicates an intermediate sensitivity, and the horizontal axis indicates a position on the line. Further, the end point on the left side of the graph 702 shown in FIG. 3 indicates an intermediate sensitivity on the left end in the main scanning direction of an image forming area of the photoconductive drum 204, and the end point on the right side indicates an intermediate sensitivity on the right side end in the main scanning direction of the image forming area of the photoconductive drum 204. Furthermore, the intermediate sensitivity distribution storing portion 111 stores intermediate sensitivity distributions for a plurality of lines. Furthermore, the intermediate distributions are advancedly obtained by an experiment and the like.

The light intensity distribution storing portion 112 stores a light intensity distribution in the main scanning direction of a laser beam. The graph 703 in FIG. 3 shows an example of a light intensity distribution in the main scanning direction of the laser beam which is stored in the light intensity distribution storing portion 112. In the graph 703, the vertical axis indicates a light intensity, and the horizontal axis indicates a position (image height) in the main scanning direction. Further, the end point on the left side of the graph 703 shown in FIG. 3 indicates a light intensity of the laser beam irradiated to the left side end in the main scanning direction of the image forming area of the photoconductive drum 204, and the end point on the right side indicates a light intensity of the laser beam irradiated to the right side end in the main scanning direction of the image forming area of the photoconductive drum 204. As shown in the graph 703 in FIG. 3, it can be seen that the light intensity increases as it goes from the left end toward the central portion in the main scanning direction, and decreases as it goes from the central portion toward the right end. Furthermore, the light intensity distributions are advancedly obtained by an experiment. Herein, the scatterings of the light intensity occurs due to a characteristic of an optical system such as fθlens which leads the laser beam to the photoconductive drum 204.

In the where a constant light intensity is provided to the photoconductive drum 204, a comparison between an electric potential at a position having a low dark electric potential and an electric potential at a position having a high dark electric potential after the exposing is performed thereto shows that the electric potential at the position having a low dark electric potential becomes lower than the electric potential at the position having a high dark electric potential. Thus, to obtain an image having a predetermined density, an emission time at a position having a low dark electric potential should be made longer than an emission time at a position having a high dark electric potential.

Further, in the case where a constant light intensity is provided to the photoconductive drum 204, a comparison between an electric potential at a position having a low intermediate sensitivity and an electric potential at a position having a high intermediate sensitivity after the exposing is performed thereto shows that the electric potential at the position having a low intermediate sensitivity becomes higher than the electric potential at the position having a high intermediate sensitivity. Thus, to obtain an image having a predetermined density, an emission time at a position having a low intermediate sensitivity should be made longer than an emission time at a position having a high intermediate sensitivity.

Further, in the case where a dark electric potential and an intermediate sensitivity of the photoconductive drum 204 is set to be constant, an emission time at a position having a low light intensity of the laser beam should be made longer than an emission time at a position having a high light intensity of the laser beam to obtain an image having a predetermined intensity.

Thus, as shown in FIG. 3, in the case where the main scanning direction is divided into three areas A, B, C for example, the area A has a high intermediate sensitivity but low light intensity and dark electric potential, the area B has a high light intensity but medium intermediate sensitivity and dark electric potential, and the area C has a low light intensity and intermediate sensitivity but high dark electric potential. Accordingly, the reference emission time stored in the reference emission time table is set, in accordance with the above-described characteristics of the photoconductive drum 204, such that the emission time becomes the shortest in an order of the areas A, B, C to obtain an image having a predetermined density.

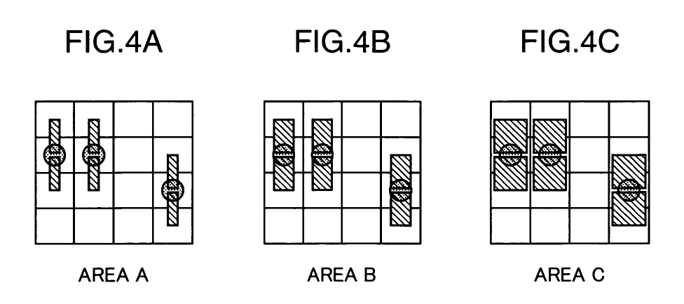

FIGS. 4A to 4C are diagrams showing output dither patterns exposed by the image forming apparatus having the characteristics shown in FIG. 3. FIG. 4A is a diagram showing the emission time in the area A in FIG. 3. FIG. 4B is a diagram showing the emission time in the area B in FIG. 3. FIG. 4C is a diagram showing the emission time in the area C in FIG. 3.

The emission time in the area A is set shorter with respect to the emission times in the areas B, C. Accordingly, as shown in FIG. 4A, it can be seen that a width in the main scanning direction of each pixel is relatively with respect to the cases of the areas B, C. The emission time in the area B is set medium with respect the emission times in the areas A, C. Accordingly, as shown in FIG. 4B, it can be seen that a width in the main scanning direction of each pixel is relatively long with respect to the emission time in the area A but relatively short with respect to the emission time in the area C. Further, the emission time in the area C is set long with respect to the emission times in the areas A, B. Accordingly, as shown in FIG. 4C, it can be seen that a width in the main scanning direction of each pixel is relatively long with respect to the emission times in the areas A, B.

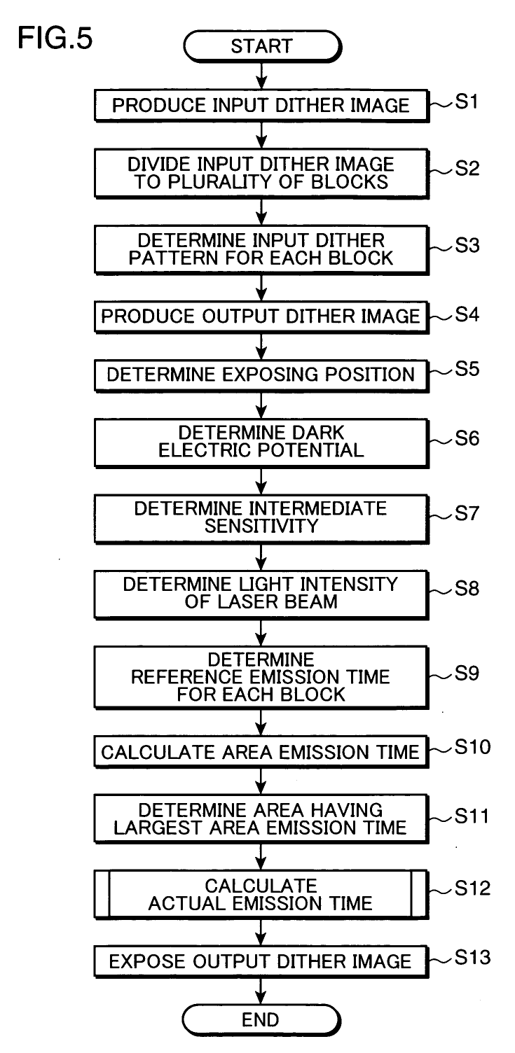

Next, an operation of the present image forming apparatus is described with reference to a flowchart in FIG. 5. At first, in Step S1, the input dither image producing portion 101 reads out image data of one original image from the image memory 40 and produces an input dither image under control of the controller 30.

Next, in Step S2, the input dither pattern determining portion 102 divides the input dither image into a plurality of blocks. Next, in Step S3, the input dither pattern determining portion 102 determines an input dither pattern corresponding to each of the divided blocks by referring to the input dither pattern storing portion 107. Next, in Step S4, the output dither image producing portion 103 produces an output dither image by referring to the output dither pattern storing portion 108 and determining an output dither pattern corresponding to the input dither pattern determined for each block.

Next, in Step S5, the reference emission time determining portion 104 determines an exposing position on the photoconductive drum 204 for each block. Next, in Step S6, the reference emission time determining portion 104 determines a dark electric potential of the photoconductive drum 204 at the determined exposing position by referring to a dark electric potential distribution stored in the dark electric potential distribution storing portion 110. Next, in Step S7, the reference emission time determining portion 104 determines an intermediate sensitivity of the photoconductive drum 204 at the determined exposing position by referring to an intermediate sensitivity distribution stored in the intermediate sensitivity distribution storing portion 111. Next, in Step S8, the reference emission time determining portion 104 determines a light intensity of the laser beam at the determined exposing position by referring to a light intensity distribution stored in the light intensity distribution storing portion 112.

Next, in Step S9, the reference emission time determining portion 104 determines a reference emission time for each block in accordance with the determined dark electric potential, intermediate sensitivity, light intensity of the laser beam and the output dither pattern by referring to the reference emission time determining table stored in the reference emission time determining table storing portion 109.

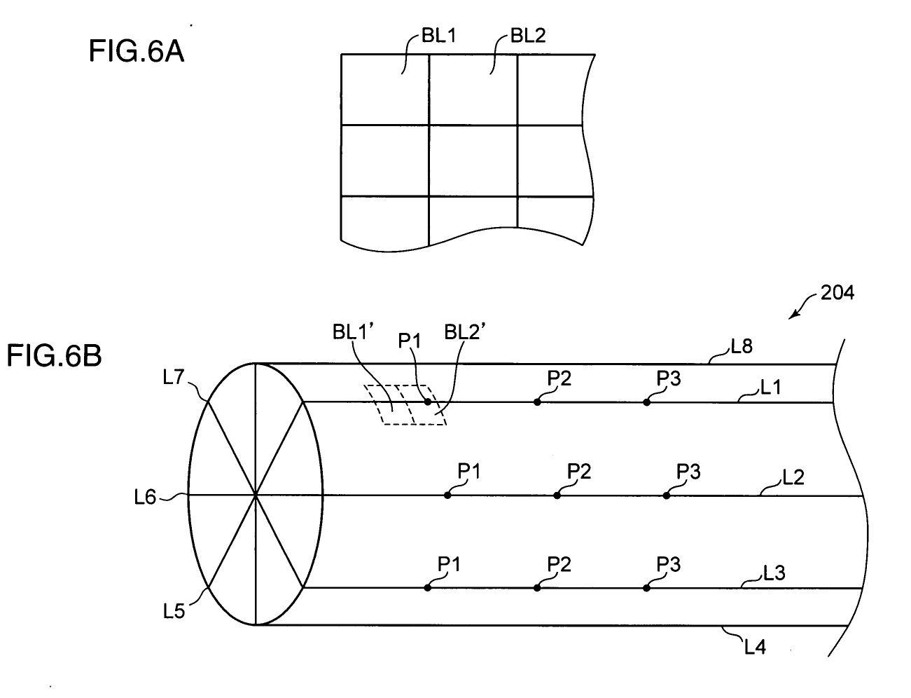

FIGS. 6A, 6B are diagrams showing a relation between each of the blocks constructing the output dither image and an exposing position. FIG. 6A is a diagram showing blocks set for the output dither image. FIG. 6B is a diagram showing the photoconductive drum 204. In the present embodiment, as shown in FIG. 6B, n sample points P1 to Pn are set respectively on each of lines L1 to L8. The lines L1 to L8 are obtained by making numbers of lines i.e. eight lines in the main scanning direction (longitudinal direction) at equal intervals on a peripheral surface of the photoconductive drum 204. A dark electric potential, an intermediate sensitivity and a light intensity of the laser beam measured in advance at each of the sample points P1 to Pn are stored respectively in the dark potential distribution storing portion 110, the intermediate sensitivity distribution storing portion 111 and the light intensity distribution storing portion 112.

Herein, the controller 30 controls the photoconductive drum 204 and the exposing device 205 such that the first line in one output dither image is exposed to the line L1 shown in FIG. 6B. Thus, the reference emission time determining portion 104 can determine an exposing position of the photoconductive drum 204 in accordance with a coordinate of an exposing pixel. If an exposing position of a block BL1 on upper left shown in FIG. 6A corresponds to the area BL1′ shown in FIG. 6B, the reference emission time determining portion 104 determines the sample point P1 on the line L1 positioned minimally spaced apart from a center of the area BL1′ among the plurality of sample points P1 to Pn on the photoconductive drum 204. Then, the reference emission time determining portion 104 determines a dark electric potential, an intermediate sensitivity and a light intensity of a laser beam of the determined sample point P1 on the line L1 by referring to the dark electric potential distribution storing portion 110, the intermediate sensitivity distribution storing portion 111 and the light intensity distribution storing portion 112.

Next, the reference emission time determining portion 104 determines a reference emission time for the block BL1 based on an output dither pattern determined for the block BL1 and the dark electric potential, intermediate sensitivity and light intensity of the sample point P1 on the line L1. The reference emission time determining portion 104 determines the reference emission time for each block by performing the above-described processings to the remaining blocks such as the block BL2.

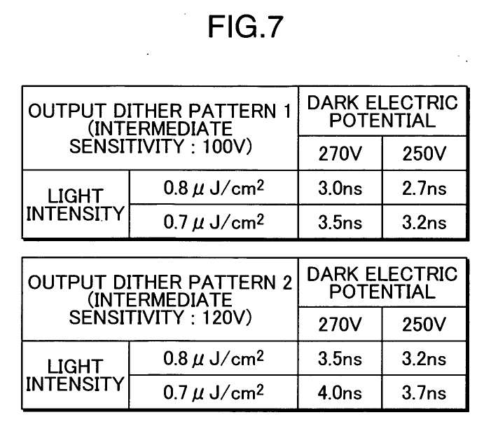

FIG. 7 shows tables showing an example of reference emission times determined by the reference emission time determining portion 104. As can be understood from the tables, for example, in the case where a dark electric potential, an intermediate sensitivity and a light intensity of the laser beam determined for one block are 270V, 100V, 0.8μJ/cm² and the output dither pattern of the block is “1”, the reference emission time determining portion 104 determines that a reference emission time for the block is 3.0 ns.

Further, for example, in the case where a dark electric potential, an intermediate sensitivity and a light intensity of the laser beam are 270V, 120V and 0.8 μJ/cm² and the output dither pattern of the block is “2”, the reference emission time determining portion 104 determines that a reference emission time for the block is 3.5 ns.

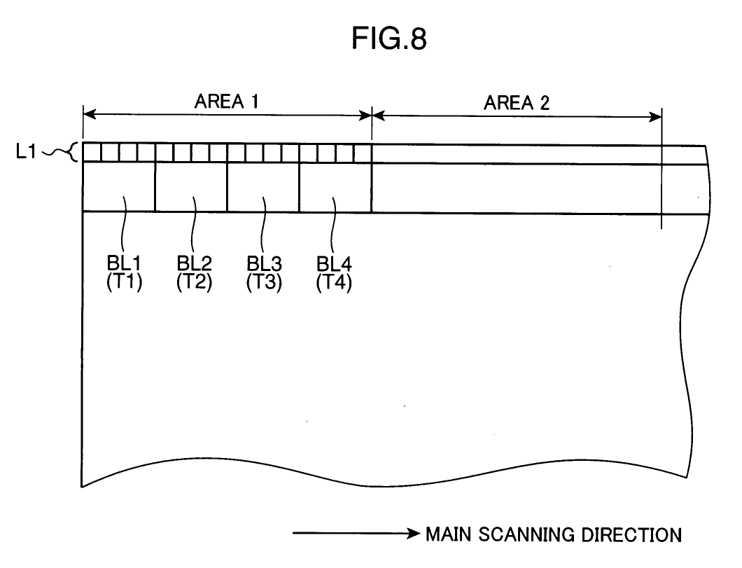

Referring back to FIG. 5, in Step S10, the area emission time calculating portion 105 divides each line in the main scanning direction into areas at intervals of a predetermined numbers of pixels, and calculates an area emission time which is a reference emission time for each area. FIG. 8 is a diagram for describing a processing of calculating an area emission time by the area emission time calculating portion 105.

At first, the area emission time calculating portion 105 divides the line L1 into a plurality of areas by dividing the line L1 in the main scanning direction of the output dither image into areas at intervals of predetermined numbers of pixels (16 pixels in FIG. 8). Next, if reference emission times of the blocks BL1 to BL4 falling in an area 1 are set to be T1, T2, T3 and T4 respectively, the area emission time calculating portion 105 calculates an average value of the reference emission times T1 to T4 and calculates the average value as the area emission time in the area 1.

It should be noted that, although the area emission time calculating portion 105 in the present embodiment determines the average value of the reference emission times for respective blocks falling in one area as an area emission time, the present invention is not particularly limited to this. A median value of reference emission times for respective blocks included in one area may be determined as an area emission time.

Referring back to FIG. 5, in Step S11, the actual emission time calculating portion 106 determines an area having the largest area emission time among the area emission times calculated respectively for areas in the main scanning direction on each line. For example, if there exists on one line six areas 1 to 6, area emission times are T1 to T6, and the area emission time T3 in the area 3 is the largest, the area 3 is set to be the largest area emission time area.

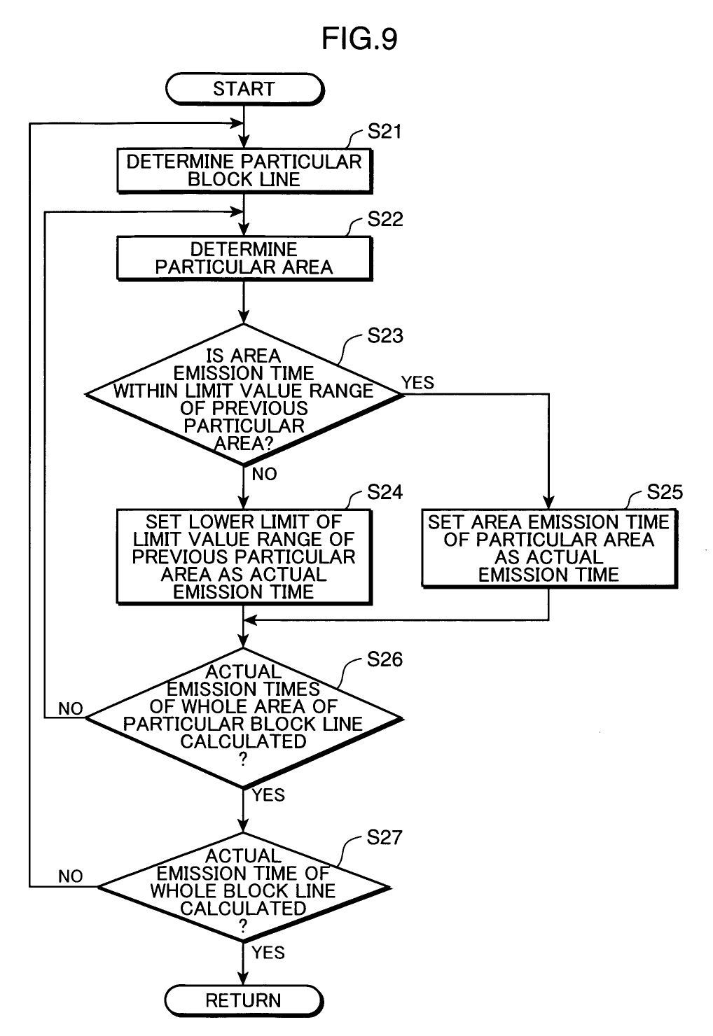

Next, in Step S12, the actual emission time calculating portion 106 calculates an actual emission time for each area based on the largest area emission time area. It should be noted that the processing of calculating the actual emission time is described hereinafter with reference to FIG. 9. Next, in Step S13, the printing section 60, under control of the controller 30, forms an image on a recording sheet by exposing the output dither image in accordance with the actual emission time calculated in the processing in Step S12.

FIG. 9 is a flowchart showing a detail of the processing of Step S12 shown in FIG. 5. At first, in Step S21, the actual emission time calculating portion 106 determines a particular block line for calculating an actual emission time among a plurality of block lines consisting of a plurality of blocks aligned in the main scanning direction of the output dither image. Herein, the actual emission time calculating portion 106 at first determines a particular block line consecutively from the first block line to the last block line in the sub scanning direction of the output dither image.

In Step S22, the actual emission time calculating portion 106 determines an area subjected to a calculation of an actual emission time as a particular area among areas included in the particular block line. Herein, the actual emission time calculating portion 106 at first determines the largest area emission time area as a particular area. Next, the actual emission time calculating portion 106 determines particular areas consecutively from the largest area emission time area toward an area positioned at the left end. When an actual emission time of the area positioned at the left end is calculated, the actual emission time calculating portion 106 determines particular areas consecutively from the largest area emission time area toward an area positioned at the right side end. It should be noted that this is merely one example. The particular area may also be determined by determining the particular area toward the right side end area at first and then toward the left side end area.

Further, in the case where the largest area emission time area is positioned at the left end, particular areas may be determined consecutively toward the right end area. Furthermore, in the case where the largest area emission time area is positioned at the right side end, the particular area may be determined consecutively toward the left end area.

In Step S23, the actual emission time calculating portion 106 determines whether or not the area emission time of a particular area falls within a predetermined limit value range with respect to an actual emission time of an adjacent previous particular area. Then, in the case where an area emission time of the particular area falls within a limit value range of an actual emission time of a previous particular area (YES in Step S23), the actual emission time calculating portion 106 calculates the area emission time of the particular area as an actual emission time in Step S25. On the other hand, in the case where an area emission time of a particular area does not fall within a limit value range with respect to an actual emission time of an adjacent previous particular area (NO in Step S23), the actual emission time calculating portion 106 calculates a lower limit of a limit value range of an actual emission time in a previous particular area as an actual emission time in Step S24.

Further, in the case where the actual emission time calculating portion 106 determines the largest area emission time area as a particular area, the actual emission time calculating portion 106 determines that an area emission time in a particular area falls within a limit value range of an actual emission time of a previous particular area even if the previous area does not exist. Then, the routine proceeds to Step 25.

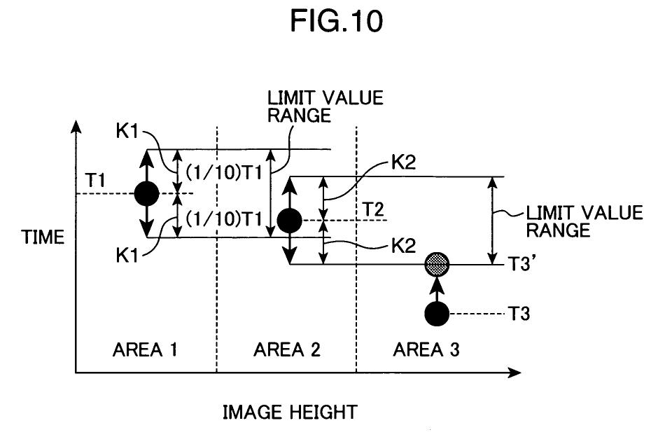

FIG. 10 is a diagram for describing processings performed in Steps S23 to S25 as shown in FIG. 9. In FIG. 10, the vertical axis indicates an area emission time or an actual emission time, and the horizontal axis indicates an image height.

In the case where the area 2 is the present particular area, an area emission time of the area 2 falls within a limit value range with respect to an actual emission time of the previous particular area 1. Accordingly, the area emission time in the area 2 is calculated as an actual emission time without any adjustment. It should be noted that the limit value range is determined as follows. For example, in the case of the area 1, if it is provided that an actual emission time of the area 1 is T1, a limit value K1 is determined by (1/10)×T1. A limit value range of the area 1 is determined to be within a range from the time calculated by subtracting the limit value K1 from the actual emission time T1 to the time calculated by adding the limit value K1 to the actual emission time T1.

On the other hand, in the case where the area 3 is the present particular area, the area emission time T3 of the area 3 does not fall within a limit value range with respect to the actual emission time of the previous particular area 2. Accordingly, the actual emission time calculating portion 106 calculates a time calculated by subtracting a limit value K2 of the area 2 from the actual emission time T2 of the area 2, namely, a lower limit of the limit value range of the area 2 as an actual emission time T3′ of the area 3.

Referring back to FIG. 9, in Step S26, the actual emission time calculating portion 106 determines whether or not a calculation of actual emission times in whole areas constructing the particular block line is terminated. Herein, in the case where it is determined that the calculation of actual emission times in whole areas is not terminated (NO in Step S26), the routine goes back to the processing in Step S22, and then the next particular area is determined. On the other hand, in the case where it is determined that a calculation of actual emission times in whole areas is completed (YES in Step S26), the routine goes back to the processing in Step S27.

In Step S27, the actual emission time calculating portion 106 determines whether or not actual emission times of whole block lines constructing the output dither image are calculated. Herein, in the case where it is determined that actual emission times of whole block lines constructing the output dither image are calculated (YES in Step S27), the processing is terminated. In the case where it is determined that actual emission times of whole block lines are not calculated (NO in Step S27), the routine goes back to the processing in Step S21, and then the next block line is determined.

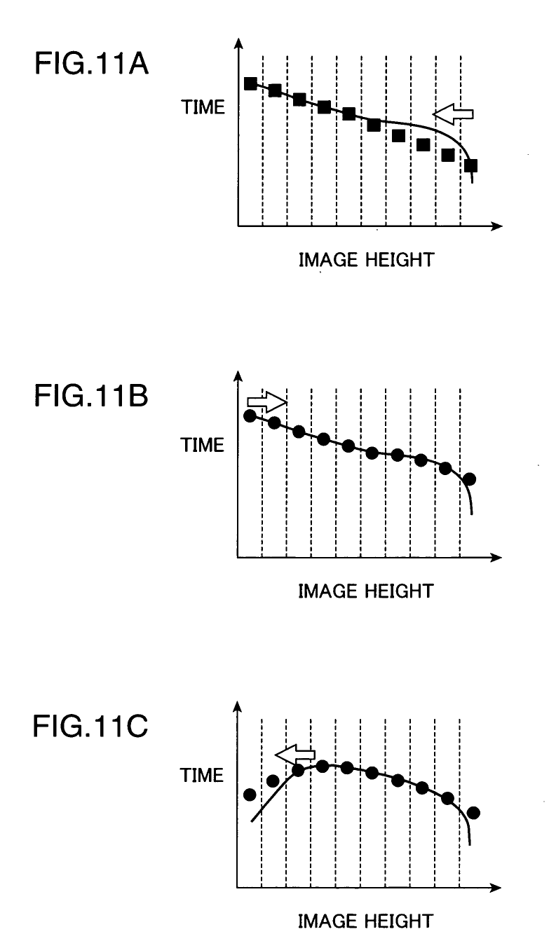

FIGS. 11A to 11C are diagrams for describing a merit of calculating actual emission times consecutively from the largest area emission time area toward an area positioned at an end. FIG. 11A is a diagram showing the case where actual emission times are not calculated consecutively from the largest area emission time area. FIG. 11B is a diagram showing the case where actual emission times are calculated consecutively from the largest area emission time area at a left end. FIG. 11C is a diagram showing the case where actual emission times are calculated consecutively from the largest area emission time area located in a vicinity of a central portion.

Further, in FIGS. 11A to 11C, the vertical axis indicates a time, and the horizontal axis shows an image height. The curved line indicates an area emission time, and rectangular or circular shape points show actual emission times. Furthermore, broken lines in FIGS. 11A to 11C indicate areas dividing the block line.

In the case of FIG. 11A, regardless of the largest area emission time area being existed at the left end, actual emission times are calculated consecutively from the right end area. Accordingly, some areas are caused to set respective actual emission times shorter than area emission times. Consequently, these areas cannot obtain a standard density determined in accordance with the area emission times. Consequently, an image reproducibility is lowered.

Namely, in the case of FIG. 11A, an actual emission time is determined such that an actual emission time in a second area from the right end falls within a limit value range with respect to an actual emission time in the right end area. However, since the right end area has an actual emission time smaller than that of the second area from the right end, an actual emission time of the second area is calculated to be smaller than the area emission time.

On the other hand, in the case where actual emission times are calculated consecutively from the largest area emission time area as shown in FIGS. 11B and 11C, actual emission times are not calculated to be smaller than area emission times. Accordingly, a standard density determined in accordance with actual emission times can be obtained. Consequently, an image reproducibility can be enhanced.

For example, in the case of FIG. 11C, actual emission times and area emission times of the first and second areas from the left end have differences. However, since the actual emission times are calculated to be larger than the area emission times, a standard density determined in accordance with area emission times can be obtained.

As described above, according to the present image forming apparatus, the input dither pattern determining portion 102 divides an input dither image which can be obtained by converting an original image to a dither image into a plurality of blocks, and determines which one of input dither patterns corresponds to a dither pattern of each block.

The output dither image producing portion 103 produces an output dither image by converting the input dither pattern determined for each block in accordance with an output dither pattern advancedly prepared for each input dither pattern.

The reference emission time determining portion 104 determines a reference emission time for each block based on a dark electric potential distribution and an intermediate sensitivity distribution of the photoconductive drum, a light intensity distribution of a laser beam in the main scanning direction, and the output dither patterns.

The area emission time calculating portion 105 divides a block line in the main scanning direction into a plurality of areas, and calculates an area emission time for each area based on a reference emission time determined for blocks falling in each area. The actual emission time calculating portion 106 calculates the actual emission time for each area that is adjusted area emission times such that a difference between the respective actual emission times of the areas adjacent to each other in the main scanning direction becomes a predetermined limit value or lower.

Namely, the reference emission time determining portion 104 determines a reference emission time to correct scatterings in the dark electric potential and the intermediate sensitivity of the photoconductive drum, and the light intensity of a laser beam in the main scanning direction. Accordingly, a reproducibility of an original image by pseudo high resolution technique can be improved.

Further, the actual emission time calculating portion 106 calculates an actual emission time for each area that is adjusted such that a difference between the respective actual emission times of the areas adjacent to each other in the main scanning direction becomes a predetermined limit value or lower. Accordingly, a difference in density between the areas adjacent to each other is lowered. Consequently, a reproducibility of an original image by pseudo high resolution technique can be improved.

Further, in the present embodiment, the photoconductive drum 204 is described as an example of an image bearing member. However, in the case where a tandem-type image forming apparatus is adapted, a transferring belt is adapted as an image bearing member. Furthermore, in the above-described embodiment, a resolution of an original image is described as being twice the reproducible resolution of the image forming apparatus. However, the present invention is not limited to this. As long as a resolution of an original image is higher than the reproducible resolution of the image forming apparatus, the present invention is applicable.

Further, the specific embodiment described above includes inventions having the constructions described herebelow.

An image forming apparatus according to one aspect of the present invention includes an image forming apparatus for forming on a recording sheet an original image having a higher resolution than a reproducible resolution by pseudo high resolution technique, the image forming apparatus comprising: an input dither image producing portion for producing an input dither image by converting an original image to a dither image; an input dither pattern determining portion for dividing the input dither image to a plurality of blocks, and determining which one of advancedly-prepared input dither patterns corresponds to a dither pattern of each block; an output dither image producing portion for producing an output dither image by converting the input dither pattern determined for each block in accordance with an advancedly-prepared output dither pattern for each input dither pattern to simulatedly form on a recording sheet the original image at a resolution of the original image; a reference emission time determining portion for determining a reference emission time indicating a laser beam emission time for each of pixels forming each block to correct, based on a dark electric potential distribution and an intermediate sensitivity distribution of an image bearing member, a light intensity distribution of a laser beam in a main scanning direction, and the output dither patterns, scatterings in the dark electric potential, the intermediate sensitivity, and the light intensity, and simulatedly form the output dither image at the resolution of the original image; and an actual emission time calculating portion for calculating an actual emission time indicating the emission time for each block that is adjusted such that a difference between the respective reference emission times of the blocks adjacent to each other in the main scanning direction becomes a predetermined value or lower.

According to the construction, the input dither pattern determining portion divides an input dither image which can be obtained by converting an original image to a dither image into a plurality of blocks, and determines which input dither pattern corresponds to a dither pattern of each block. Herein, there exist various kinds of advancedly-prepared input dither patterns.

The output dither image producing portion converts the input dither pattern determined for each block into the output dither pattern advancedly prepared for each input dither pattern. Herein, the output dither patterns are dither patterns which are advanced prepared to simulatedly form on a recording sheet an original image having a resolution which is higher than the reproducible resolution of the image forming apparatus at a resolution of the original image.

The reference emission time determining portion determines a reference emission time for each block based on a dark electric potential distribution and an intermediate sensitivity distribution of the image bearing member, a light intensity distribution of the laser beam in a main scanning direction, and the output dither pattern. Herein, an emission time of the laser beam for each of pixels forming each block is determined by the reference emission time.

The actual emission time calculating portion adjusts the reference emission time such that a difference between the respective reference emission times of the blocks adjacent to each other in the main scanning direction becomes a predetermined value or lower, and calculates the actual emission time of each block.

Namely, the reference emission time determining portion determines the reference emission time for each block such that scatterings in the dark electric potential and the intermediate sensitivity of the image bearing member, and the light intensity of the laser beam in a main scanning direction are corrected, and the output dither image is simulatedly formed at the resolution of the original image. Accordingly, the reproducibility of the original image by the pseudo high resolution technique can be enhanced.

Further, since the actual emission time calculating portion calculates an actual emission time for each block such that a difference between the respective reference emission times of the blocks adjacent to each other in the main scanning direction becomes a predetermined value or lower, a difference between the respective densities of the blocks adjacent to each other is lowered. Accordingly, a reproducibility of the original image by the pseudo high resolution technique can be enhanced.

Further, in the above-described construction, it is preferable that the image forming apparatus further comprises: a dark electric potential distribution storing portion for storing in advance a dark potential distribution of the image bearing member; an intermediate sensitivity distribution storing portion for storing in advance an intermediate sensitivity distribution of the image bearing member; a light intensity distribution storing portion for storing in advance a light intensity distribution of a laser beam to the image bearing member; and a reference emission time table storing portion for storing in advance a table showing a relation between the dark electric potential, the intermediate sensitivity, the light intensity and the output dither pattern, and the reference emission time, and that the reference emission time determining portion determines a dark electric potential of the image bearing member for each block by referring to the dark potential distribution storing portion, an intermediate sensitivity of the image bearing member for each block by referring to the intermediate sensitivity distribution storing portion, and a light intensity of the laser beam for each block by referring to the light intensity distribution storing portion, and reads out from the reference emission time table storing portion the reference emission time for each block corresponding to the determined dark electric potential, intermediate sensitivity, light intensity and output dither pattern.

According to this construction, the dark electric distribution storing portion stores in advance a dark potential distribution of the image bearing member, the intermediate sensitivity distribution storing portion stores in advance an intermediate sensitivity distribution of the image bearing member, and the light intensity distribution storing portion stores in advance a light intensity distribution of a laser beam to the image bearing member. The reference emission time table storing portion stores in advance a table showing a relation between the dark electric potential, the intermediate sensitivity, the light intensity and the output dither pattern, and the reference emission time. The reference emission time determining portion determines a dark electric potential of the image bearing member for each block by referring to the dark potential distribution storing portion, an intermediate sensitivity of the image bearing member for each block by referring to the intermediate sensitivity distribution storing portion, and a light intensity of the laser beam for each block by referring to the light intensity distribution storing portion. Consecutively, the reference emission time determining portion reads out from the reference emission time table storing portion the reference emission time for each block corresponding to the determined dark electric potential, intermediate sensitivity, light intensity and output dither pattern.

According to this, the reference emission time for each block can be easily determined, and the scattering of the dark electric potential, intermediate sensitivity and light intensity of a laser beam in a main scanning direction on the image bearing member can be easily corrected.

Further, in the above-described construction, it is preferable that the dark potential distribution storing portion stores a dark electric potential measured in advance at a plurality of sample points set on the image bearing member; the intermediate sensitivity distribution storing portion stores an intermediate sensitivity measured in advance at the plurality of sample points; the light intensity distribution storing portion stores a light intensity of the laser beam measured in advance at the plurality of sample points; and the reference emission time determining portion determines the exposing position on the image bearing member that corresponds to a coordinate of an exposing pixel of the output dither image, and determines a sample point positioned minimally spaced apart from a center of each block of the output dither image among the plurality of sample points on the image bearing member, and determines a dark electric potential, an intermediate sensitivity and a light intensity of the laser beam to the specified sample point by referring to the dark electric potential distribution storing portion, the intermediate sensitivity distribution storing portion and the light intensity distribution storing portion.

According to this construction, the dark potential distribution storing portion stores a dark electric potential measured in advance at a plurality of sample points set on the image bearing member, the intermediate sensitivity distribution storing portion stores an intermediate sensitivity measured in advance at the plurality of sample points, and the light intensity distribution storing portion stores a light intensity of the laser beam measured in advance at the plurality of sample points. The reference emission time determining portion determines the exposing position on the image bearing member that corresponds to a coordinate of an exposing pixel of the output dither image. After that, the reference emission time determining portion determines a sample point positioned minimally spaced apart from a center of each block of the output dither image among the plurality of sample points on the image bearing member, and determines a dark electric potential, an intermediate sensitivity and a light intensity of the laser beam to the specified sample point by referring to the dark electric potential distribution storing portion, the intermediate sensitivity distribution storing portion and the light intensity distribution storing portion. Accordingly, a dark electric potential, an intermediate sensitivity and a light intensity of the laser beam for each block can be easily determined.

Further, in the above-described construction, it is preferable that the image forming apparatus further comprises an area emission time calculating portion for dividing the output dither image to a plurality of areas in the main scanning direction, and calculating an area emission time for each area based on a reference emission time determined for blocks falling in each area, and that the actual emission time calculating portion calculates the actual emission time for each area that is adjusted such that a difference between the respective emission times of the areas adjacent to each other in the main scanning direction becomes a predetermined value or lower.

According to this construction, the area emission time calculating portion determines an area emission time based on a reference emission time determined for blocks falling in each area. The actual emission time calculating portion calculates the actual emission time for each area that is adjusted the area emission time such that a difference between the respective reference emission times of the areas adjacent to each other in the main scanning direction becomes a predetermined value or lower. Accordingly, the actual emission is determined for each area. Consequently, simplification of the control can be attained.

Further, in the above-described construction, it is preferable that the area emission time calculating portion calculates an average value of the respective reference emission times determined for the blocks of an area falling in a specified one of the plurality of areas as an area emission time of the particular area.

According to this construction, an average value of the respective reference emission times determined for each block falling in a specific one of the plurality of areas is calculated as an area emission time of the specific one area. Accordingly, an area emission time can be easily calculated.

Further, in the above-described construction, it is preferable that the actual emission time calculating portion calculates the actual emission time for each area such that an actual emission time of the particular area subjected to a calculation of the actual emission time has an actual emission time falling within a range which is one-tenth of the actual emission time of adjacent area higher or lower than the actual emission time of adjacent area.

According to this construction, a difference between the respective actual emission times of the areas adjacent to each other can be made one-tenth or lower. Accordingly, a difference between the respective densities of the areas adjacent to each other can be more lowered.

Further, in the above-described construction, it is preferable that the actual emission time calculating portion calculates, in the case where an area emission time of a particular area subjected to calculation of an actual emission time does not fall within a predetermined range with respect to an actual emission time of an adjacent area, the actual emission time of the particular area so as to fall in the range.

According to this construction, a difference between the respective actual emission times of the areas adjacent to each other can be more assuredly made smaller. Accordingly, a difference between the respective densities of the areas adjacent to each other can be more lowered.

Further, in the above-described construction, it is preferable that the actual emission time calculating portion determines an area having the largest area emission time of each block line consisting of blocks aligned in the main scanning direction, calculates an actual emission time consecutively from the determined area toward an area positioned at an end of the block line, and calculates a lower limit of a predetermined range as an actual emission time of the particular area in the case where the area emission time of the particular area does not fall within the predetermined range with respect to an actual emission time of an adjacent area.

According to this construction, an actual emission time is calculated consecutively from an area having the largest reference emission time toward an area positioned at an end of the block line. In the case where the area emission time of the particular area does not fall within the predetermined range with respect to an actual emission time of an adjacent area, a lower limit of the predetermined range is calculated as an actual emission time of the particular area. Accordingly, an actual emission time which is not greatly different from an area emission time and makes smaller the difference between the respective densities of the areas adjacent to each other can be calculated.

This application is based on patent application No. 2006-002778 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image forming apparatus for forming on a recording sheet an original image having a higher resolution than a reproducible resolution by pseudo high resolution technique, the image forming apparatus comprising:
an input dither image producing portion for producing an input dither image by converting an original image to a dither image;
an input dither pattern determining portion for dividing the input dither image to a plurality of blocks, and determining which one of advancedly-prepared input dither patterns corresponds to a dither pattern of each block;
an output dither image producing portion for producing an output dither image by converting the input dither pattern determined for each block in accordance with an advancedly-prepared output dither pattern for each input dither pattern to simulatedly form on a recording sheet the original image at a resolution of the original image;
a reference emission time determining portion for determining a reference emission time indicating a laser beam emission time for each of pixels forming each block to correct, based on a dark electric potential distribution and an intermediate sensitivity distribution of an image bearing member, a light intensity distribution of a laser beam in a main scanning direction, and the output dither patterns, scatterings in the dark electric potential, the intermediate sensitivity, and the light intensity, and simulatedly form the output dither image at the resolution of the original image; and
an actual emission time calculating portion for calculating an actual emission time indicating the emission time for each block that is adjusted such that a difference between the respective reference emission times of the blocks adjacent to each other in the main scanning direction becomes a predetermined value or lower.

2. An image forming apparatus according to claim 1, further comprising:
a dark electric potential distribution storing portion for storing in advance a dark potential distribution of the image bearing member;
an intermediate sensitivity distribution storing portion for storing in advance an intermediate sensitivity distribution of the image bearing member;
a light intensity distribution storing portion for storing in advance a light intensity distribution of a laser beam to the image bearing member; and
a reference emission time table storing portion for storing in advance a table showing a relation between the dark electric potential, the intermediate sensitivity, the light intensity and the output dither pattern, and the reference emission time, wherein
the reference emission time determining portion determines a dark electric potential of the image bearing member for each block by referring to the dark potential distribution storing portion, an intermediate sensitivity of the image bearing member for each block by referring to the intermediate sensitivity distribution storing portion, and a light intensity of the laser beam for each block by referring to the light intensity distribution storing portion, and reads out from the reference emission time table storing portion the reference emission time for each block corresponding to the determined dark electric potential, intermediate sensitivity, light intensity and output dither pattern.

3. An image forming apparatus according to claim 2, wherein:
the dark potential distribution storing portion stores a dark electric potential measured in advance at a plurality of sample points set on the image bearing member;
the intermediate sensitivity distribution storing portion stores an intermediate sensitivity measured in advance at the plurality of sample points;
the light intensity distribution storing portion stores a light intensity of the laser beam measured in advance at the plurality of sample points; and
the reference emission time determining portion determines the exposing position on the image bearing member that corresponds to a coordinate of an exposing pixel of the output dither image, and determines a sample point positioned minimally spaced apart from a center of each block of the output dither image among the plurality of sample points on the image bearing member, and determines a dark electric potential, an intermediate sensitivity and a light intensity of the laser beam to the specified sample point by referring to the dark electric potential distribution storing portion, the intermediate sensitivity distribution storing portion and the light intensity distribution storing portion.

4. An image forming apparatus according to claim 1, further comprising an area emission time calculating portion for dividing the output dither image to a plurality of areas in the main scanning direction, and calculating an area emission time for each area based on a reference emission time determined for blocks falling in each area, wherein
the actual emission time calculating portion calculates the actual emission time for each area that is adjusted such that a difference between the respective emission times of the areas adjacent to each other in the main scanning direction becomes a predetermined value or lower.

5. An image forming apparatus according to claim 4, wherein the area emission time calculating portion calculates an average value of the respective reference emission times determined for the blocks of an area falling in a specified one of the plurality of areas as an area emission time of the specific one area.

6. An image forming apparatus according to claim 4, wherein the actual emission time calculating portion calculates the actual emission time for each area such that an actual emission time of the particular area subjected to a calculation of the actual emission time has an actual emission time falling within a range which is one-tenth of the actual emission time of adjacent area higher or lower than the actual emission time of adjacent area.

7. An image forming apparatus according to claim 4, wherein the actual emission time calculating portion calculates, in the case where an area emission time of a particular area subjected to calculation of an actual emission time does not fall within a predetermined range with respect to an actual emission time of an adjacent area, the actual emission time of the particular area so as to fall in the range.

8. An image forming apparatus according to claim 7, wherein the actual emission time calculating portion determines an area having the largest area emission time of each block line consisting of blocks aligned in the main scanning direction, calculates an actual emission time consecutively from the determined area toward an area positioned at an end of the block line, and calculates a lower limit of a predetermined range as an actual emission time of the particular area in the case where the area emission time of the particular area does not fall within the predetermined range with respect to an actual emission time of an adjacent area.
